(19) United States
(12) Patent Application Publication
(10) Pub. No.: US 2022/0277568 A1
(43) Pub. Date: Sep. 1, 2022

(54) VEHICLE PERIPHERY MONITORING DEVICE AND VEHICLE PERIPHERY MONITORING SYSTEM

(71) Applicant: TOYOTA JIDOSHA KABUSHIKI KAISHA, Toyota-shi Aichi-ken (JP)

(72) Inventors: Yuki Takahashi, Nagoya-shi Aichi-ken (JP); Yohei Satomi, Okazaki-shi Aichi-ken (JP)

(21) Appl. No.: 17/673,394

(22) Filed: Feb. 16, 2022

(30) Foreign Application Priority Data
Mar. 1, 2021 (JP) 2021-032087

(51) Int. Cl. G06V 20/56; G06T 5/00; B60S 1/56; B60K 35/00

(52) U.S. Cl. CPC G06V 20/56; G06T 5/00; B60S 1/56; B60K 35/00; G06T 2207/30252; G06T 2207/10024; B60K 2370/152; B60K 2370/21

(57) ABSTRACT

A vehicle periphery monitoring device includes: an image acquisition section configured to acquire an image of a vehicle periphery; a first image correction section configured to correct an acquired image according to an environment of the vehicle periphery; a second image correction section configured to perform correction for determining whether or not dirt appears in the acquired image; a display switching section configured to switch between a display mode in which a first corrected image corrected by the first image correction section is displayed at a display section that is inside a vehicle cabin, and a non-display mode in which the first corrected image is not displayed at the display section; and a dirt detection section configured to detect for dirt at the imaging device based on a second corrected image corrected by the second image correction section.

### CROSS-REFERENCE TO RELATED APPLICATION

This application is based on and claims priority under 35 USC 119 from Japanese Patent Application No. 2021-032087 filed on Mar. 1, 2021, the disclosure of which is incorporated by reference herein.

### BACKGROUND

### Technical Field

The present disclosure relates to a vehicle periphery monitoring device and a vehicle periphery monitoring system.

### Related Art

Japanese Patent Application Laid-Open (JP-A) No. 2020-050014 discloses a configuration including a rear camera configured to image rearward from a vehicle from inside a vehicle cabin, through a rear windshield. In JP-A No. 2020-050014, in a state in which a vehicle rearward image captured by the rear camera is displayed at an electronic interior mirror, an imaging range of the rear camera is selectively wiped by a rear wiper in order to remove dirt.

Performing specific corrections on captured images facilitates dirt detection when detecting for dirt that has adhered to the lens of an imaging device such as a camera. However, in cases in which correction for the purpose of dirt detection is performed on a display image, as in JP-A No. 2020-050014, and in cases in which correction for the purpose of dirt detection is performed on an image to be recorded, a state in the periphery of such an image might be unclear to an viewer.

### SUMMARY

The present disclosure provides a vehicle periphery monitoring device and a vehicle periphery monitoring system capable of effectively detecting dirt on an imaging device while ensuring occupant usability.

A first aspect of the present disclosure including: an image acquisition section configured to acquire an image of a vehicle periphery captured by an imaging device; a first image correction section configured to correct an acquired image according to an environment of the vehicle periphery; a second image correction section configured to perform correction for determining whether or not dirt appears in the acquired image; a display switching section configured to switch between a display mode in which a first corrected image corrected by the first image correction section is displayed at a display section that is inside a vehicle cabin, and a non-display mode in which the first corrected image is not displayed at the display section; an image recording section configured to record the first corrected image; and a dirt detection section configured to correct the image using the second image correction section at a predetermined timing in the non-display mode, and to detect for dirt at the imaging device based on a second corrected image corrected by the second image correction section.

In the vehicle periphery monitoring device according to the first aspect of the present disclosure, the image acquisition section acquires the vehicle periphery image (image information) captured by the imaging device. The first image correction section corrects the image acquired by the image acquisition section according to the vehicle peripheral environment. The display switching section switches between the display mode in which the first corrected image corrected by the first image correction section is displayed at the display section inside the vehicle cabin, and the non-display mode in which the first corrected image is not displayed at the display section. The image recording section records the first corrected image. In this manner, the first corrected image is displayed at the display section, and the first corrected image is also recorded, thereby enabling an image that is clear to an occupant to be displayed and recorded.

The second image correction section performs correction for the purpose of determining whether or not dirt appears in the image acquired by the image acquisition section. The dirt detection section corrects the image using the second image correction section at a predetermined timing in the non-display mode, and detects for dirt on the imaging device based on the second corrected image thus corrected. The second corrected image that is corrected for the purpose of dirt detection is therefore not displayed. Moreover, detecting for dirt on the imaging device based on the second corrected image enables more effective dirt detection than in cases in which the first corrected image is employed for this purpose.

In a second aspect of the present disclosure, in the first aspect, the dirt detection section may be configured to correct the image using the second image correction section when an obstacle is not detected in the vehicle periphery.

In the vehicle periphery monitoring device according to the second aspect of the present disclosure, the image is corrected using the second image correction section at a timing when obstacles are not detected in the vehicle periphery, thereby enabling a situation in which the second corrected image is displayed and recorded to be avoided. Namely, in a situation in which an obstacle has been detected in the vehicle periphery, a captured image may be displayed at the display section inside the vehicle cabin in order to notify the occupant. Were this to be performed following correction by the second image correction section, the image would not be clear to the occupant. Accordingly, performing this image correction at a timing when obstacles are not detected in the vehicle periphery enables any detriment to occupant usability to be avoided.

In a third aspect of the present disclosure, in the first aspect or the second aspect, the dirt detection section may be configured to correct the image using the second image correction section when neither sudden acceleration or deceleration nor sudden steering is detected.

In the vehicle periphery monitoring device according to the third aspect of the present disclosure, the image is corrected using the second image correction section at a timing when neither sudden acceleration or deceleration nor sudden steering is detected, thereby enabling a situation in which the second corrected image is recorded to be avoided. Namely, in a situation in which sudden acceleration or deceleration or sudden steering are detected, a captured image may be recorded. Were this to be performed following correction by the second image correction section, the image would not be clear to the occupant. Accordingly, performing this image correction at a timing when neither sudden acceleration or deceleration nor sudden steering is detected enables any detriment to occupant usability to be avoided.

In a fourth aspect of the present disclosure, in any one of the first aspect to the third aspect, the dirt detection section may be configured to correct the image using the second image correction section when a direction indicator is not in operation.

In the vehicle periphery monitoring device according to the fourth aspect of the present disclosure, the image is corrected using the second image correction section at a timing when the direction indicator is not in operation, thereby enabling a situation in which the second corrected image is recorded to be avoided. Namely, in a situation in which the direction indicator is in operation, a captured image may be recorded if for example a collision occurs while turning left or right. Were this to be performed following correction by the second image correction section, the image would not be clear to the occupant. Accordingly, performing this image correction at a timing when the direction indicator is not in operation enables any detriment to occupant usability to be avoided.

In a fifth aspect of the present disclosure, in any one of the first aspect to the fourth aspect, the dirt detection section may be configured to correct the image using the second image correction section when a steering angle is smaller than a predetermined angle.

In the vehicle periphery monitoring device according to the fifth aspect of the present disclosure, the image is corrected using the second image correction section at a timing when the steering angle is smaller than the predetermined angle, thereby enabling a situation in which the second corrected image is recorded to be avoided. Namely, in a situation in which the steering angle is the predetermined angle or greater, a captured image may be recorded as a result of a collision or the like. Were this to be performed following correction by the second image correction section, the image would not be clear to the occupant. Accordingly, performing this image correction at a timing when the steering angle is less than the predetermined angle enables any detriment to occupant usability to be avoided.

In a sixth aspect of the present disclosure, in the first aspect, the dirt detection section may be configured to correct the image using the second image correction section in a case in which a proportion of a low brightness region having a lower brightness than a threshold in the acquired image is a set value or greater.

In the vehicle periphery monitoring device according to the sixth aspect of the present disclosure, dirt is determined to be present in cases in which the low brightness region proportion is the set value or greater, and in such cases image correction is performed using the second image correction section. This enables dirt on the imaging device to be efficiently detected.

In a seventh aspect of the present disclosure, in the sixth aspect, the set value is changed according to a light level of the vehicle periphery.

In the vehicle periphery monitoring device according to the seventh aspect of the present disclosure, the set value may be changed according to the light level in the vehicle periphery, thereby enabling the presence of dirt to be more accurately determined. For example, since the light level in the vehicle periphery differs between day and night, changing the set value according to the light level in the vehicle periphery enables the presence of dirt to be accurately determined from the low brightness region proportion, irrespective of the light level in the vehicle periphery.

In an eighth aspect of the present disclosure, in the sixth aspect, the threshold may be changed according to a light level of the vehicle periphery.

In the vehicle periphery monitoring device according to the eighth aspect of the present disclosure, the threshold is changed according to the light level in the vehicle periphery, thereby enabling the presence of dirt to be more accurately determined. For example, since the light level in the vehicle periphery differs between day and night, changing the threshold according to the light level in the vehicle periphery enables determination as to whether or not the brightness is low irrespective of the light level in the vehicle periphery, thereby enabling the presence of dirt to be accurately determined.

In a ninth aspect of the present disclosure, in any one of the first aspect to the eighth aspect, the first image correction section may be configured to correct brightness and coloring of the image according to a light level of the vehicle periphery; and the second image correction section is configured to correct the image so as to emphasize edges and contrast.

In the vehicle periphery monitoring device according to the ninth aspect of the present disclosure, the first image correction section corrects brightness and coloring of the image according to the light level in the vehicle periphery, thereby enabling an image that is clear to the occupant to be displayed. The second image correction section corrects the image so as to emphasize edges and contrast, thereby enabling indicators that serves as dirt detection criteria to be easily identified, enabling an improvement in dirt detection precision.

A tenth aspect of the present disclosure is a vehicle periphery monitoring system including: the vehicle periphery monitoring device of any one of claim 1 to claim 9; an imaging device configured to image a vehicle periphery; and a cleaning device configured to clean the imaging device, wherein the imaging device is cleaned by the cleaning device in a case in which dirt has been detected at the imaging device by the dirt detection section.

In the vehicle periphery monitoring system according to the tenth aspect of the present disclosure, the imaging device is cleaned by the cleaning device in cases in which dirt has been detected at the imaging device. This enables dirt detection and cleaning to be effectively performed.

As described above, the vehicle periphery monitoring device and the vehicle periphery monitoring system according to the present disclosure are capable of effectively detecting dirt on the imaging device while ensuring occupant usability.

### BRIEF DESCRIPTION OF THE DRAWINGS

Exemplary embodiments of the present disclosure will be described in detail based on the following figures, wherein:

FIG. 1 is a block diagram illustrating a hardware configuration of a vehicle periphery monitoring system according to a first exemplary embodiment;

FIG. 2 is a block diagram illustrating a functional configuration of a vehicle periphery monitoring device according to the first exemplary embodiment;

FIG. 3 is a flowchart illustrating an example of a flow of dirt detection processing of the first exemplary embodiment;

FIG. 4 is a block diagram illustrating a functional configuration of a vehicle periphery monitoring device according to a second exemplary embodiment; and

FIG. 5 is a flowchart illustrating an example of a flow of dirt detection processing of the second exemplary embodiment.

### DETAILED DESCRIPTION

### First Exemplary Embodiment

Explanation follows regarding a vehicle periphery monitoring system 10 (referred to hereafter as the “periphery monitoring system 10” as appropriate) applied with a vehicle periphery monitoring device 12 (referred to hereafter as the “periphery monitoring device 12” as appropriate) according to a first exemplary embodiment, with reference to the drawings. The periphery monitoring device 12 of the present exemplary embodiment is installed in a vehicle as an example; however, there is no limitation thereto, and the periphery monitoring device 12 may be provided at a location other than a vehicle, such as a service center.

Hardware Configuration of Periphery Monitoring System 10

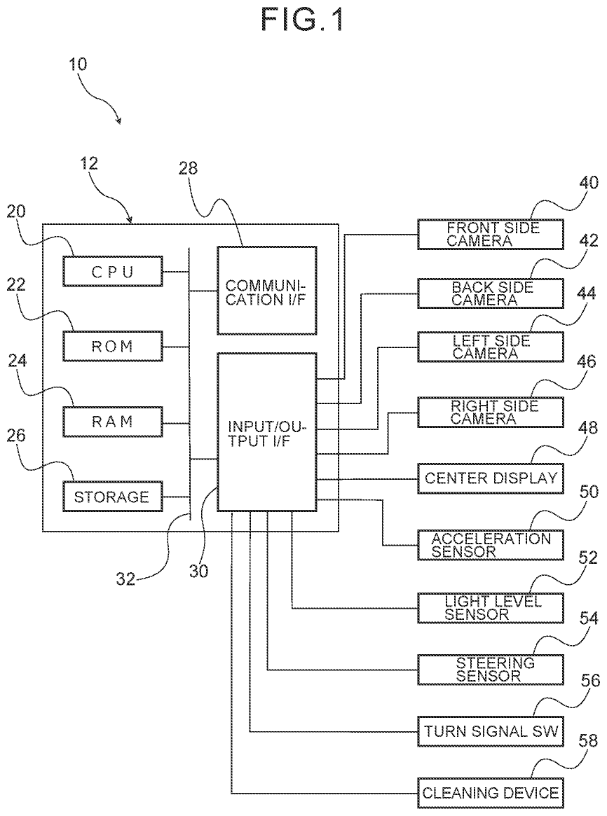

FIG. 1 is a block diagram illustrating a hardware configuration of the periphery monitoring system 10. As illustrated in FIG. 1, the periphery monitoring device 12 is configured including a central processing unit (CPU; processor) 20, read only memory (ROM) 22, random access memory (RAM) 24, storage 26, a communication interface 28, and an input/output interface 30. The respective configurations are connected together so as to be capable of communicating with each other through a bus 32.

The CPU 20 is a central processing unit that executes various programs and controls various sections. Namely, the CPU 20 reads a program from the ROM 22 or the storage 26, and executes the program using the RAM 24 as a workspace. The CPU 20 controls the respective configurations mentioned above and performs various arithmetic processing according to the program recorded in the ROM 22 or the storage 26.

The ROM 22 holds various programs and various data. The RAM 24 serves as a workspace that temporarily stores programs and data. The storage 26 is configured by a hard disk drive (HDD) or a solid state drive (SSD), and holds various programs including an operating system, as well as various other data. In the present exemplary embodiment, the ROM 22 or the storage 26 holds a program for performing dirt detection processing, various other data, and so on.

The communication interface 28 is an interface through which the periphery monitoring device 12 communicates with a non-illustrated server and other equipment. For example, a controller area network (CAN), Ethernet (registered trademark), long term evolution (LTE), fiber distributed data interface (FDDI), or Wi-Fi (registered trademark) protocol may be employed therefor.

A front side camera 40, a back side camera 42, a left side camera 44, a right side camera 46, a center display 48 serving as a display section, an acceleration sensor 50, a light level sensor 52, a steering sensor 54, a turn signal switch 56 serving as a direction indicator, and a cleaning device 58 are electrically connected to the input/output interface 30.

The front side camera 40, the back side camera 42, the left side camera 44, and the right side camera 46 each correspond to an “imaging device” of the present disclosure. The front side camera 40 is provided at a front section of the vehicle, and performs forward imaging from the vehicle. The back side camera 42 is provided at a rear section of the vehicle, and performs rearward imaging from the vehicle. The left side camera 44 is provided at a left side section of the vehicle, and performs imaging toward the left from the vehicle. The right side camera 46 is provided at a right side section of the vehicle, and performs imaging toward the right from the vehicle.

The center display 48 is, for example, provided in a front section of a vehicle cabin at a position where it can be seen by a driver, and is used to display various information. The information displayed at the center display 48 includes entertainment programing in the form of movies or television, information relating to obstacles in the vehicle periphery, vehicle information, and the like.

The acceleration sensor 50 detects acceleration of the vehicle. The light level sensor 52 detects a light level in the vehicle periphery. The steering sensor 54 detects a steering angle of the vehicle. The turn signal switch 56 is a switch used to activate flashing turn signal lamps, and is turned on and off by driver operation. Accordingly, when the turn signal switch 56 is operated by the driver, the periphery monitoring system 10 ascertains via the input/output interface 30 that the turn signal switch 56 has been turned on.

The cleaning device 58 is a device used to clean at least one camera out of the front side camera 40, the back side camera 42, the left side camera 44, or the right side camera 46 that configure imaging devices. For example, a device that swings a wiping member such as a wiper blade so as to wipe away dirt adhering to the lens of an imaging device may be employed as a cleaning device 58. A device that sprays water toward the lens of an imaging device and a device that blows air toward the lens of an imaging device may be employed as other cleaning devices 58. The cleaning device 58 is actuated by a signal from the periphery monitoring device 12 in order to clean the corresponding imaging device. Although only a single cleaning device 58 is illustrated in FIG. 1, dedicated cleaning devices may be provided for each of the front side camera 40, the back side camera 42, the left side camera 44, and the right side camera 46.

Functional Configurations of Periphery Monitoring Device 12

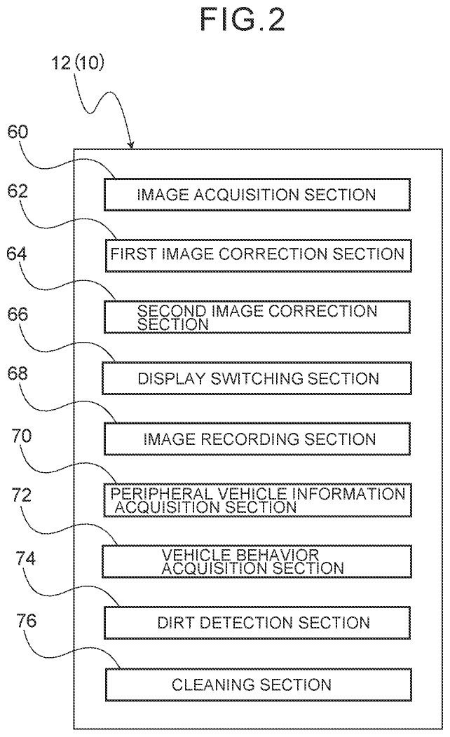

The periphery monitoring device 12 implements various functionality using the hardware recourses described above. Explanation follows regarding functional configurations implemented by the periphery monitoring device 12, with reference to FIG. 2.

As illustrated in FIG. 2, the functional configurations of the periphery monitoring device 12 are configured including an image acquisition section 60, a first image correction section 62, a second image correction section 64, a display switching section 66, an image recording section 68, a vehicle periphery information acquisition section 70, a vehicle behavior acquisition section 72, a dirt detection section 74, and a cleaning section 76. The respective functional configurations are implemented by the CPU 20 reading and executing the program stored in the ROM 22 or the storage 26.

The image acquisition section 60 acquires images of the vehicle periphery captured by the imaging devices. Specifically, the image acquisition section 60 acquires images captured by the front side camera 40, the back side camera 42, the left side camera 44, and the right side camera 46 respectively.

The first image correction section 62 corrects the images acquired by the image acquisition section 60 according to an environment in the vehicle periphery. As an example, in the present exemplary embodiment, the first image correction section 62 corrects the brightness and coloring of each image according to the light level in the vehicle periphery, an average brightness of the image, and a color shade of the image. Namely, the first image correction section 62 corrects the image to a coloring and brightness close to those of the scene as perceived by the human eye.

The second image correction section 64 corrects images so as to emphasize edges and contrast. As an example, in the present exemplary embodiment, the second image correction section 64 corrects images acquired by the image acquisition section 60 for the purpose of determining whether dirt appears in the image. Specifically, the second image correction section 64 emphasizes edges and contrast in order to enable recognition of indicators such as white lines that are used as dirt detection criteria. The second image correction section 64 also adjusts the image brightness according to the light level in the vehicle periphery and the light level of the indicators in order to suppress external noise other than dirt.

The display switching section 66 switches between a display mode in which a first corrected image corrected by the first image correction section 62 is displayed at the center display 48 inside the vehicle cabin, and a non-display mode in which the first corrected image is not displayed at the center display 48. For example, the display switching section 66 switches to the non-display mode such that the first corrected image is not displayed at the center display 48 when in a state in which entertainment programing is being displayed at the center display 48 in response to driver operation or the like. On the other hand, the display switching section 66 switches to the display mode in order to display, for example, a camera image in which an obstacle has been detected at the center display 48 in cases in which an obstacle requiring attention has been detected in the vehicle periphery. Moreover, the display switching section 66 switches to the display mode such that a reversing guide monitor image is displayed at the center display 48 when a shift lever has been switched to an R range.

The image recording section 68 records the first corrected image corrected by the first image correction section 62. Specifically, in cases in which the first corrected image is being displayed at the center display 48 by the display switching section 66, the image recording section 68 temporarily records the displayed first corrected image in a recording section such as the RAM 24 or the storage 26. The image recording section 68 also temporarily records the corrected first corrected image in the RAM 24, the storage 26, or the like in cases in which an image has been corrected by the first image correction section 62, even if the first corrected image is not being displayed at the center display 48.

The vehicle periphery information acquisition section 70 acquires information regarding the vehicle periphery. For example, the vehicle periphery information acquisition section 70 acquires vehicle periphery information by detecting obstacles from the images captured by the front side camera 40, the back side camera 42, the left side camera 44, and the right side camera 46. The vehicle periphery information acquisition section 70 may also acquire vehicle periphery information using non-illustrated radar or sensors provided to the vehicle.

The vehicle behavior acquisition section 72 acquires vehicle behavior. Specifically, the vehicle behavior acquisition section 72 detects sudden acceleration or deceleration of the vehicle based on signals from the acceleration sensor 50. The vehicle behavior acquisition section 72 also detects sudden steering of the vehicle based on information from the steering sensor 54. The vehicle behavior acquisition section 72 also detects a situation in which the vehicle is turning left or right based on signals from the turn signal switch 56.

The dirt detection section 74 uses the second image correction section 64 to correct an image at a predetermined timing in the non-display mode, and detects for dirt on a target imaging device based on a second corrected image thus corrected. For example, the dirt detection section 74 performs correction on an image captured by the front side camera 40 using the second image correction section 64, and detects for dirt on the front side camera 40 based on the second corrected image thus corrected.

The dirt detection section 74 of the present exemplary embodiment computes brightness of the second corrected image corrected by the second image correction section 64, and detects as dirt any region in which a proportion of a low brightness region that is a region having a lower brightness than a threshold is a set value or greater. Moreover, even in cases in which the brightness of an imaging range is not inconsistent, in cases in which the overall contrast is low, the dirt detection section 74 detects this as adhered dirt such as an oily film or water droplets.

Note that in the present exemplary embodiment, the dirt detection section 74 uses the second image correction section 64 to perform image correction at a timing when obstacles are not detected in the vehicle periphery by the vehicle periphery information acquisition section 70. The dirt detection section 74 also uses the second image correction section 64 to perform image correction at a timing when neither sudden acceleration or deceleration nor sudden steering are detected by the vehicle behavior acquisition section 72.

The dirt detection section 74 also uses the second image correction section 64 to perform image correction at a timing when the turn signal switch 56 is not in operation. Moreover, the dirt detection section 74 uses the second image correction section 64 to perform image correction at a timing when the steering angle detected by the steering sensor 54 is less than a predetermined angle.

The cleaning section 76 uses the cleaning device 58 to clean any camera on which dirt has been detected by the dirt detection section 74 out of the front side camera 40, the back side camera 42, the left side camera 44, or the right side camera 46.

Operation

Next, explanation follows regarding operation of the present exemplary embodiment.

Example of Dirt Detection Processing

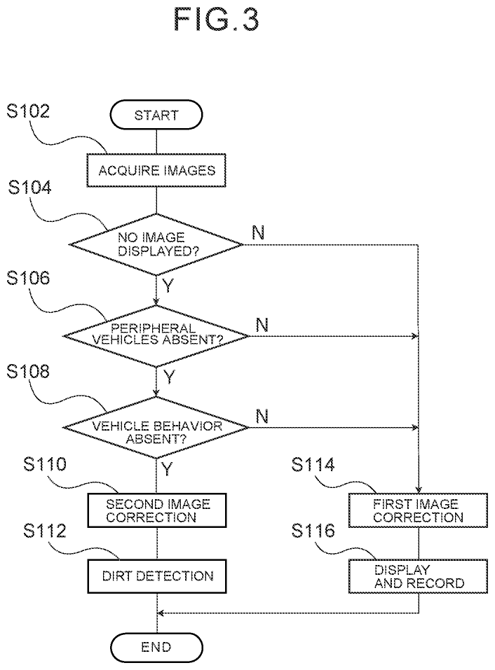

FIG. 3 is a flowchart illustrating an example of a flow of dirt detection processing performed by the vehicle periphery monitoring device 12. This dirt detection processing is executed by the CPU 20 reading the corresponding program from the ROM 22 or the storage 26, and expanding the program in the RAM 24.

As illustrated in FIG. 3, at step S102, the CPU 20 acquires images. Specifically, the CPU 20 uses the functionality of the image acquisition section 60 to acquire an image captured by each of the front side camera 40, the back side camera 42, the left side camera 44, and the right side camera 46.

At step S104, the CPU 20 determines whether or not an image is being displayed at a display section such as the center display 48. Specifically, at step S104, the CPU 20 uses the functionality of the display switching section 66 to acquire the mode, namely either the display mode or the non-display mode. In cases in which the mode is the non-display mode, determination is affirmative at step S104, and processing transitions to step S106. In cases in which the mode is the display mode, determination is negative at step S104, and processing transitions to step S114. The processing of step S114 will be described later.

At step S106, the CPU 20 determines whether or not any peripheral vehicles are present. Specifically, in cases in which the CPU 20 determines based on a signal from the vehicle periphery information acquisition section 70 that peripheral vehicles have not been detected, determination is affirmative at step S106, and processing transitions to step S108. On the other hand, in cases in which the CPU 20 determines based on a signal from the vehicle periphery information acquisition section 70 that a peripheral vehicle has been detected, determination is negative at step S106, and processing transitions to step S114.

At step S108, the CPU 20 determines whether or not vehicle behavior is present. Specifically, in cases in which the CPU 20 has detected neither sudden acceleration or deceleration nor sudden steering of the vehicle using the functionality of the vehicle behavior acquisition section 72, and the turn signal switch 56 is off, determination is affirmative at step S108 and processing transitions to step S110. On the other hand, in cases in which the CPU 20 has detected sudden acceleration or deceleration, sudden steering, or a left or right turn of the vehicle using the functionality of the vehicle behavior acquisition section 72, determination is negative at step S108 and processing transitions to step S114. Moreover, in cases in which the turn signal switch 56 is on, the CPU 20 makes a negative determination at step S108 and processing transitions to step S114.

At step S110, the CPU 20 performs image correction using the second image correction section 64. Namely, in cases in which the determinations of step S104, step S106, and step S108 are all affirmative determinations, the CPU 20 uses the functionality of the second image correction section 64 to perform image correction for the purpose of dirt detection. At step S112, the CPU 20 then performs dirt detection based on the second corrected image. Note that the CPU 20 uses the functionality of the dirt detection section 74 in order to perform dirt detection. The CPU 20 then ends the dirt detection processing.

On the other hand, in cases in which negative determination has been made at step S104, step S106, or step S108, the CPU 20 uses the first image correction section 62 to perform image correction at step S114. Specifically, the CPU 20 corrects the brightness and coloring of the images acquired by the image acquisition section 60 according to the light level in the vehicle periphery, the average brightness of the image, and the color shade of the image. Then, at step S116, the CPU 20 displays the first corrected image on the center display 48 and temporarily records the first corrected image in the RAM 24 and the storage 26. The CPU 20 then ends the dirt detection processing.

As described above, in the present exemplary embodiment, the first corrected image corrected by the first image correction section 62 is displayed at the center display 48 and the first corrected image is also recorded, thereby enabling an image that is clear to an occupant to be displayed and recorded.

The dirt detection section 74 uses the second image correction section 64 to perform image correction at a predetermined timing in the non-display mode, and detects for dirt on the imaging devices, for example the front side camera 40, the back side camera 42, the left side camera 44, and the right side camera 46, based on the second corrected image thus corrected. The second corrected image that is corrected for the purpose of dirt detection is therefore not displayed at the center display 48. Moreover, detecting dirt on the imaging devices based on the second corrected image enables more effective dirt detection than in cases in which the first corrected image is employed for this purpose.

Moreover, in the present exemplary embodiment, images are corrected by the second image correction section 64 at a timing when obstacles are not detected in the vehicle periphery, thereby enabling a situation in which the second corrected image is displayed and recorded to be avoided. Namely, in a situation in which an obstacle has been detected in the vehicle periphery, a captured image may be displayed at the center display 48 in order to notify the occupant. Were this to be performed following correction by the second image correction section 64, the image would not be clear to the occupant. Accordingly, performing this image correction at a timing when obstacles are not detected in the vehicle periphery enables any detriment to occupant usability to be avoided.

Furthermore, in the present exemplary embodiment, images are corrected by the second image correction section 64 at a timing when neither sudden acceleration or deceleration nor sudden steering is detected, thereby enabling a situation in which the second corrected image is recorded to be avoided. Namely, in a situation in which sudden acceleration or deceleration or sudden steering are detected, images that have been temporarily recorded in the RAM 24 or the storage 26 may, for example, be transferred to another recording section in order to check the circumstances. Were this to be performed following correction by the second image correction section 64, the image would not be clear to the occupant. Accordingly, performing this image correction at a timing when neither sudden acceleration or deceleration nor sudden steering is detected enables any detriment to occupant usability to be avoided.

Moreover, in the present exemplary embodiment, images are corrected by the second image correction section 64 at a timing when the turn signal switch 56 is not in operation, thereby enabling a situation in which the second corrected image is recorded to be avoided. Namely, in cases in which a collision occurs while turning left or right, a captured image may, for example, be transferred to another recording section in order to check the circumstances. Were this to be performed following correction by the second image correction section 64, the image not be clear to the occupant. Accordingly, performing this image correction at a timing when the turn signal switch 56 is not in operation enables any detriment to occupant usability to be avoided.

Moreover, in the present exemplary embodiment, images are corrected by the second image correction section 64 at a timing when the steering angle is less than a predetermined angle, thereby enabling a situation in which the second corrected image is recorded to be avoided. Namely, in a situation in which the steering angle is the predetermined angle or greater, a captured image may be recorded as a result of a collision or the like. Were this to be performed following correction by the second image correction section 64, the image would not be clear to the occupant. Accordingly, performing this image correction at a timing when the steering angle is less than the predetermined angle enables any detriment to occupant usability to be avoided.

Moreover, in the present exemplary embodiment, the first image correction section 62 corrects brightness and coloring of images according to the light level in the vehicle periphery, thereby enabling images that are clear to the occupant to be displayed at a display section such as the center display 48. The second image correction section 64 corrects images so as to emphasize edges and contrast, thereby enabling indicators that serves as dirt detection criteria to be easily identified, enabling an improvement in dirt detection precision.

### Second Exemplary Embodiment

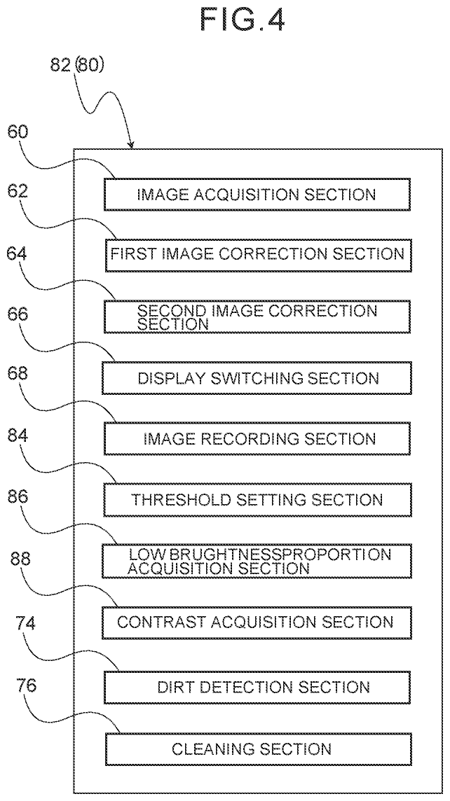

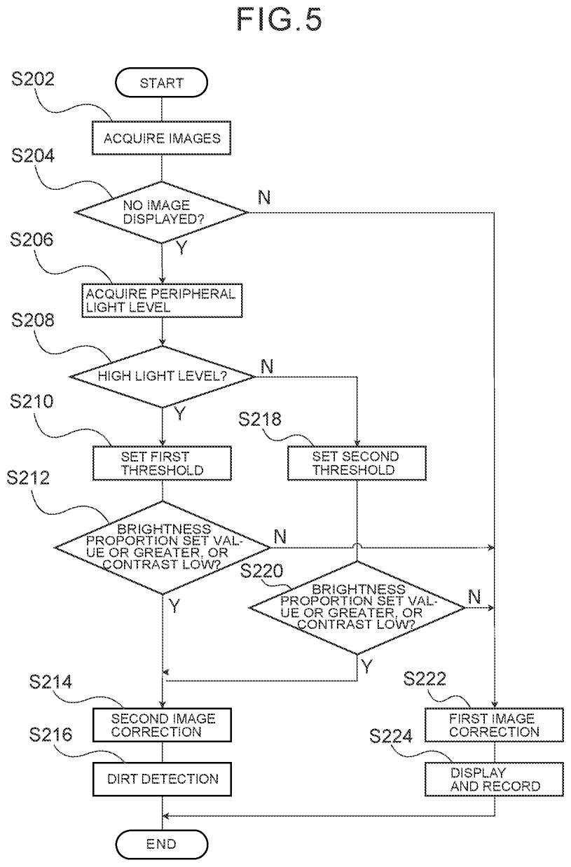

Next, explanation follows regarding a vehicle periphery monitoring device 82 according to a second exemplary embodiment, with reference to FIG. 4 and FIG. 5. Note that configurations similar to those of the first exemplary embodiment are allocated the same reference numerals, and explanation thereof is omitted as appropriate. A vehicle periphery monitoring system 80 of the present exemplary embodiment has a similar hardware configuration to that of the first exemplary embodiment illustrated in FIG. 1.

Functional Configuration of Periphery Monitoring Device 82

The periphery monitoring device 82 employs the hardware resources illustrated in FIG. 1 to implement various functionality. Explanation follows regarding functional configurations implemented by the periphery monitoring device 82, with reference to FIG. 4.

As illustrated in FIG. 4, the functional configurations of the periphery monitoring device 82 are configured including the image acquisition section 60, the first image correction section 62, the second image correction section 64, the display switching section 66, the image recording section 68, a threshold setting section 84, a low brightness proportion acquisition section 86, a contrast acquisition section 88, the dirt detection section 74, and the cleaning section 76. The respective functional configurations are implemented by the CPU 20 reading and executing the program stored in the ROM 22 or the storage 26.

Note that the present exemplary embodiment differs to the first exemplary embodiment in the respect that image correction is performed by the second image correction section 64 in cases in which dirt has been detected using basic dirt detection. Specifically, the first image correction section 62 performs image correction on images acquired by the image acquisition section 60, and a proportion of a low brightness region is computed for the first corrected images thus corrected. In cases in which the low brightness region proportion is a set value or greater, image correction is performed by the second image correction section 64 in order to detect for dirt.

The threshold setting section 84 illustrated in FIG. 4 sets a threshold for determining low brightness. Specifically, the threshold setting section 84 sets the threshold to either a first threshold or a second threshold according to the light level in the vehicle periphery, in order to set an appropriate threshold for the basic dirt detection. For example, in cases in which the light level in the vehicle periphery is comparatively high, for example during the daytime, the threshold is set to the higher first threshold by the threshold setting section 84. Conversely, in cases in which the light level in the vehicle periphery is low, for example at night, the threshold is changed to the second threshold by the threshold setting section 84, this being lower than the first threshold. Thus, portion where the brightness is lower due to a factor other than dirt are not determined to be a low brightness region. Namely, for any given image, setting the second threshold will result in a lower proportion being determined to be low brightness than when the first threshold is set. Note that as an example, in the present exemplary embodiment, the threshold setting section 84 is configured so as to be capable of setting two thresholds, namely the first threshold and the second threshold; however, there is no limitation thereto. For example, the threshold setting section 84 may be configured so as to be capable of setting three or more thresholds.

The low brightness proportion acquisition section 86 acquires the proportion of the first corrected image corrected by the first image correction section 62 that has low brightness. Specifically, the low brightness proportion acquisition section 86 defines a portion having a lower brightness than the threshold set by the threshold setting section 84 as a low brightness region, and computes the proportion of low brightness region in the overall image.

The contrast acquisition section 88 acquires contrast for the first corrected image corrected by the first image correction section 62. As an example, in the present exemplary embodiment, the contrast acquisition section 88 computes a maximum brightness in the first corrected image as a denominator and a minimum brightness in the first corrected image as a numerator. Note that the contrast acquisition section 88 acquires the contrast in order to detect for dirt resulting from the adhesion of an oily film, water droplets, or the like. Namely, in a state in which an oily film or water droplets have adhered to the entire lens of the imaging device, the image might not be properly focused due to the oily film or water droplets even if the low brightness region proportion is more than the set value. Since such cases result in a drop in contrast, acquiring the contrast of the first corrected image using the contrast acquisition section 88 enables contrast information to be employed in dirt detection.

Operation

Next, explanation follows regarding operation of the present exemplary embodiment.

Example of Dirt Detection Processing

FIG. 5 is a flowchart illustrating an example of a flow of dirt detection processing by the periphery monitoring device 82. This dirt detection processing is executed by the CPU 20 reading the corresponding program from the ROM 22 or the storage 26, and expanding the program in the RAM 24.

As illustrated in FIG. 5, at step S202, the CPU 20 acquires images. Specifically, the CPU 20 uses the functionality of the image acquisition section 60 to acquire an image captured by each of the front side camera 40, the back side camera 42, the left side camera 44, and the right side camera 46.

At step S204, the CPU 20 determines whether or not an image is being displayed at a display section such as the center display 48. Specifically, at step S204, the CPU 20 uses the functionality of the display switching section 66 to acquire the mode, namely either the display mode or the non-display mode. In cases in which the mode is the non-display mode, determination is affirmative at step S204, and processing transitions to step S206.

On the other hand, in cases in which the mode is the display mode, determination is negative at step S204, and processing transitions to step S222. The processing of step S222 onward will be described later.

In cases in which the mode is the non-display mode, at step S206, the CPU 20 acquires the light level in the vehicle periphery. Specifically, the CPU 20 receives the light level as detected by the light level sensor 52 illustrated in FIG. 1 in order to acquire the light level in the vehicle periphery.

At step S208, the CPU 20 determines whether or not the light level in the vehicle periphery is high. Specifically, the CPU 20 determines that the light level is high in cases in which the light level in the vehicle periphery acquired at step S206 is higher than a predetermined set value. In such cases, determination is affirmative at step S208, and processing transitions to step S210.

At step S210, the CPU 20 sets the threshold for low brightness determination to the first threshold. The threshold is set using the functionality of the threshold setting section 84. Then, at step S212, the CPU 20 determines whether or not the low brightness proportion is large. Specifically, the CPU 20 uses the functionality of the low brightness proportion acquisition section 86 to acquire the proportion of the low brightness region having a lower brightness than the first threshold in the first corrected image corrected by the first image correction section 62. In cases in which the low brightness proportion is the set value or greater, the CPU 20 determines the low brightness proportion to be large, and processing transitions to step S214. Moreover, even if the low brightness proportion is not the set value or greater, in cases in which the contrast of the first corrected image is lower than a predetermined value, determination is affirmative at step S212 and processing transitions to step S214. As an example, in the present exemplary embodiment, affirmative determination is made at step S212 in cases in which the contrast is so low that the license numbers of peripheral vehicles cannot be detected. In cases in which the low brightness proportion is not the set value or greater and the contrast is also larger than the predetermined set value at step S212, the CPU 20 makes a negative determination at step S212, and processing transitions to step S222.

On the other hand, at step S208, in cases in which the CPU 20 determines that the light level in the vehicle periphery is lower than the predetermined set value, processing transitions to step S218. At step S218, the CPU 20 sets the threshold for low brightness determination to the second threshold that is lower than the first threshold. The threshold is set using the functionality of the threshold setting section 84. Then at step S220, the CPU 20 determines whether or not the low brightness proportion is large. Specifically, the CPU 20 uses the functionality of the low brightness proportion acquisition section 86 to acquire the proportion of the low brightness region having a lower brightness than the second threshold in the first corrected image corrected by the first image correction section 62. In cases in which the low brightness proportion is the set value or greater, the CPU 20 determines the low brightness proportion to be large, and processing transitions to step S214. Moreover, even if the low brightness proportion is not the set value or greater, in cases in which the contrast of the first corrected image is lower than a predetermined value, determination is affirmative at step S220 and processing transitions to step S214. In cases in which the low brightness proportion is not the set value or greater at step S220 and the contrast is also higher than the predetermined set value at step S220, the CPU 20 makes a negative determination at step S220, and processing transitions to step S222.

As described above, in cases in which the CPU 20 makes an affirmative determination at step S212 and in cases in which the CPU 20 makes an affirmative determination at step S220, processing transitions to step S214. At step S214, the CPU 20 performs image correction using the functionality of the second image correction section 64. Next, at step S216, the CPU 20 uses the functionality of the dirt detection section 74 to perform dirt detection. The CPU 20 then ends the dirt detection processing.

Conversely, in cases in which the CPU 20 makes negative determination at step S204, in cases in which the CPU 20 makes negative determination at step S212, and in cases in which the CPU 20 makes a negative determination at step S220, processing transitions to step S222. At step S222, the CPU 20 uses the functionality of the first image correction section 62 to perform image correction. Then at step S224, the CPU 20 displays the first corrected image on the center display 48, and temporarily records the first corrected image in the RAM 24 or the storage 26. The CPU 20 then ends the dirt detection processing. Accordingly, dirt detection is not performed in cases in which the mode is the display mode, in cases in which the low brightness proportion is small, and in cases in which the contrast is higher than the predetermined set value.

As described above, in the present exemplary embodiment, dirt is determined to be present in cases in which the low brightness region proportion in the first corrected image corrected by the first image correction section 62 is the set value or greater, and in such cases image correction is performed using the second image correction section 64. This enables basic dirt detection to be performed for the first corrected image, thus enabling dirt on an imaging device to be efficiently detected.

Moreover, in the present exemplary embodiment, the threshold setting section 84 changes the threshold according to the light level in the vehicle periphery, thereby enabling dirt to be detected more accurately than in configurations in which the threshold is not changed. For example, since the light level in the vehicle periphery differs between day and night, changing the threshold according to the light level in the vehicle periphery as in the present exemplary embodiment enables dirt to be accurately detected, irrespective of the light level in the vehicle periphery. Other operation is similar to that of the first exemplary embodiment.

Although explanation has been given regarding the periphery monitoring devices 12, 82 according to the first exemplary embodiment and the second exemplary embodiment, obviously various modifications may be implemented within a range not departing from the spirit of the present disclosure. For example, although four cameras, namely the front side camera 40, the back side camera 42, the left side camera 44, and the right side camera 46 are employed as imaging devices in the exemplary embodiments described above, there is no limitation thereto, and configuration may be made with the front side camera 40 alone. Alternatively, configuration may be made with only two cameras, namely the front side camera 40 and the back side camera 42.

Although in the exemplary embodiments described above image correction by the second image correction section 64 is performed in cases in which the mode is the non-display mode, peripheral vehicles are not present, and predetermined vehicle behavior is absent as illustrated in FIG. 3, there is no limitation thereto. For example, the determination of step S108 may be omitted, such that image correction by the second image correction section 64 is performed in cases in which the mode is the non-display mode and peripheral vehicles are not present. Alternatively, processing may transition from step S108 to step S110 without making determination for information regarding the turn signal switch 56 in cases in which neither sudden acceleration or deceleration nor sudden steering of the vehicle are detected. However, from the perspective of reliably recording the first corrected image in a situation such as a vehicle collision, a determination for information regarding the turn signal switch 56 is included in some embodiments.

Moreover, although configuration is made such that the threshold for low brightness determination is set to either the first threshold or the second threshold in the second exemplary embodiment, there is no limitation thereto. For example, configuration may be made such that the threshold for low brightness determination is not changed, but the set value for determining whether the low brightness proportion is large or small is changed. In such cases, the processing of step S210 and step S218 in the flowchart of FIG. 5 is omitted. Moreover, the set value for determining whether or not the low brightness proportion is large at step S212 and the set value for determining whether or not the low brightness proportion is large at step S220 may be set to different values. For example, the set value employed at step S220 may be set larger than the set value employed at step S212, such that dirt is only detected to be present in cases in which the low brightness proportion is sufficiently large in situations in which the light level in the vehicle periphery is low.

Moreover, the dirt detection processing executed by the CPU 20 reading and executing a program in the first exemplary embodiment and the second exemplary embodiment may be executed by various types of processor other than the CPU 20. Such processors include programmable logic devices (PLD) that allow circuit configuration to be modified post-manufacture, such as a field-programmable gate array (FPGA), and dedicated electric circuits, these being processors including a circuit configuration custom-designed to execute specific processing, such as an application specific integrated circuit (ASIC). The dirt detection processing may be executed by any one of these various types of processor, or by a combination of two or more of the same type or different types of processor, such as plural FPGAs, or a combination of a CPU and an FPGA. The hardware structure of these various types of processors is more specifically an electric circuit combining circuit elements such as semiconductor elements.

Moreover, although various data is recorded in the storage 26 in the first exemplary embodiment and the second exemplary embodiment, there is no limitation thereto. For example, a recording medium such as a compact disc (CD), digital versatile disc (DVD), or universal serial bus (USB) memory may be employed as a storage section. In such cases, the various programs, data, and so on are held in such recording media.

What is claimed is:

1. A vehicle periphery monitoring device comprising:
an image acquisition section configured to acquire an image of a vehicle periphery captured by an imaging device;
a first image correction section configured to correct an acquired image according to an environment of the vehicle periphery;
a second image correction section configured to perform correction for determining whether or not dirt appears in the acquired image;
a display switching section configured to switch between a display mode in which a first corrected image corrected by the first image correction section is displayed at a display section that is inside a vehicle cabin, and a non-display mode in which the first corrected image is not displayed at the display section;
an image recording section configured to record the first corrected image; and
a dirt detection section configured to correct the image using the second image correction section at a predetermined timing in the non-display mode, and to detect for dirt at the imaging device based on a second corrected image corrected by the second image correction section.

2. The vehicle periphery monitoring device of claim 1, wherein the dirt detection section is configured to correct the image using the second image correction section when an obstacle is not detected in the vehicle periphery.

3. The vehicle periphery monitoring device of claim 1, wherein the dirt detection section is configured to correct the image using the second image correction section when neither sudden acceleration or deceleration nor sudden steering is detected.

4. The vehicle periphery monitoring device of claim 1, wherein the dirt detection section is configured to correct the image using the second image correction section when a direction indicator is not in operation.

5. The vehicle periphery monitoring device of claim 1, wherein the dirt detection section is configured to correct the image using the second image correction section when a steering angle is smaller than a predetermined angle.

6. The vehicle periphery monitoring device of claim 1, wherein the dirt detection section is configured to correct the image using the second image correction section in a case in which a proportion of a low brightness region having a lower brightness than a threshold in the acquired image is a set value or greater.

7. The vehicle periphery monitoring device of claim 6, wherein the set value is changed according to a light level of the vehicle periphery.

8. The vehicle periphery monitoring device of claim 6, wherein the threshold is changed according to a light level of the vehicle periphery.

9. The vehicle periphery monitoring device of claim 1, wherein:
the first image correction section is configured to correct brightness and coloring of the image according to a light level of the vehicle periphery; and
the second image correction section is configured to correct the image so as to emphasize edges and contrast.

10. A vehicle periphery monitoring system comprising:
the vehicle periphery monitoring device of claim 1;
an imaging device configured to image a vehicle periphery; and
a cleaning device configured to clean the imaging device,
wherein the imaging device is cleaned by the cleaning device in a case in which dirt has been detected at the imaging device by the dirt detection section.
